(19) United States
(12) Patent Application Publication
(10) Pub. No.: US 2009/0236348 A1
(43) Pub. Date: Sep. 24, 2009

(54) One meal deal

(76) Inventor: Christopher Tyson, Kalamazoo, MI (US)

Correspondence Address: Christopher Tyson, 1010 Dayton Avenue, Kalamazoo, MI, 49048, US

(21) Appl. No.: 12/077,616

(22) Filed: Mar. 20, 2008

(51) Int. Cl. A47J 27/00; B65D 25/04; B65D 25/28

(52) U.S. Cl. 220/573.1; 220/553; 220/752

(57) ABSTRACT

A improved round, oval shaped cooking container having divided walls (10a), interconnecting with a second dividing wall (10a), which communicates to create three separate cooking compartments which are (10), (11) and (12). In addition with one divide wall extending from one side of the cooking container to another. A bottom wall (10b), and perimeter wall upwardly extending around the bottom wall (10c) and upper edge defining an open top into the respective cooking container (10d), creates the three cooking compartments and helps to place the magnets and smaller cooking container in the cooking compartment.

### BACKGROUND

1. Field of Invention

This invention relates to a cooking container, specifically to such having a three compartment, placing two smaller cooking container on top of magnets, which are in the same size similar cooking compartments.

2. Description of Prior Art

Grocery stores, supermarkets and retail stores commonly supply consumers with cooking pans or cooking containers for cooking food in. Such cooking containers are used by suppliers to provide a cooking container to cook food. Originally you had one empty, round cooking container. However cooking in one pan, consumers objective since there were of a rather permanent nature: the cooking container could only cook one food at one-time. There after inventors created several types of cooking containers to more foods in one container. U.S. Pat. No. 6,189,722 shows a cooking container having several (2) Cooking containers. Thus if the cooking container is completely filled to the top and has so many sections, it makes it hard to cook a lot of food. Also, being tall and deep and having up to five cooking compartments, it makes hard to cook several foods at one time. Although the different cooking compartments are there, the cannot be used to create a meat and needs more manipulation to cook. The cooking container heretofore known suffer from a number disadvantages. Several types of cooking containers have be proposed—for example Feb. 20, 2001 patent number: U.S. Pat. No. 6,189,722 B1, shows several brief description of a cooking container. The cooking container heretofore known suffer from a number of disadvantages:
(a) there is no compartment big enough to cook a variety of different foods, for example a piece of meat.
(b) the cooking container are all of the same size, in length and width
© the cooking container does not have three cooking compartments, to create three different cooking areas of space.
   (d) taking food out of the cooking container is difficult

### DRAWING FIGURES

In the drawings, closely related figures have the same number but different alphabetic suffixes.

FIG. 1, is a plan view of a typical embodiment of the utensil in plan view to show the complementary inner structure.

FIG. 2, is a schematic perspective view of a first embodiment of a cooking container of the present invention.

FIG. 3, is a schematic perspective view of a just embodiment of a cooking container of the present invention.

FIG. 4, is a schematic perspective view of second and third embodiments of a cooking container of the present invention.

FIG. 5, is a schematic perspective view of a fourth embodiment of a cooking container of the present invention.

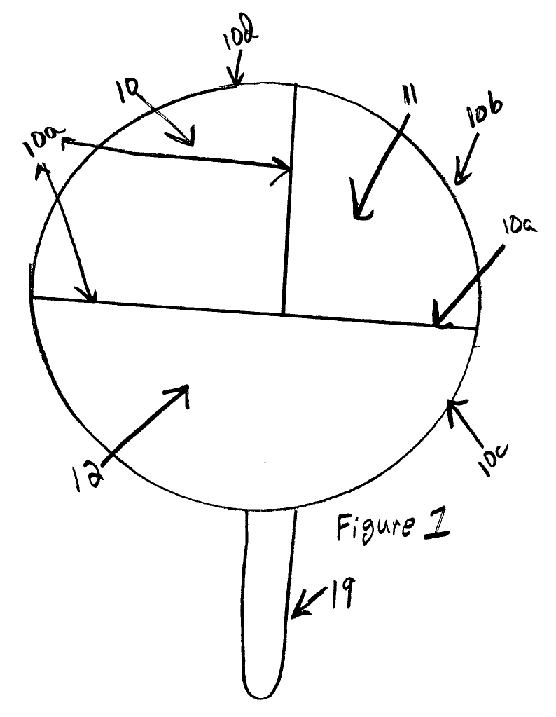

### REFERENCE NUMERALS IN DRAWINGS FOR FIG. 1

10a the dividing walls
10b bottom wall
10c perimeter wall upwardly extending around the bottom wall
10d a upper edge defining an open top into the respective cooking container
10 cooking compartment
11 cooking compartment
12 cooking compartment
10 handle

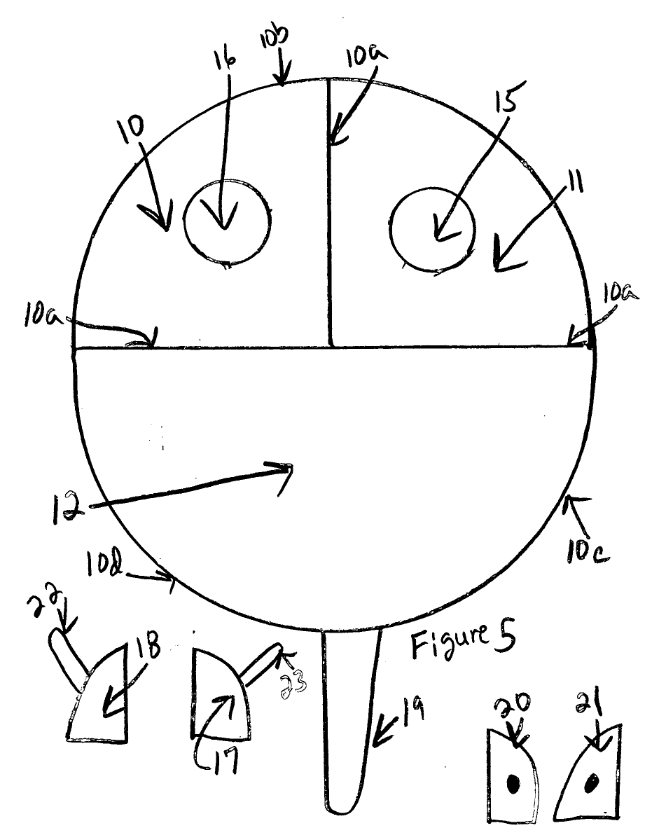

### REFERENCE NUMERICAL IN DRAWINGS FOR FIG. 5

10a dividing walls
10b bottom wall
10c a perimeter wall upwardly extending around the bottom wall
10d an upper edge defining an open top into the respective cooking container
10 cooking compartment
11 cooking compartment
12 cooking compartment
15 magnets
16 magnets
17 two smaller cooking containers
18 two smaller cooking containers
19 handle
20 lids or covers for small cooking containers
21 lids or covers for small cooking containers
22 handles for small cooking containers
23 handle for small cooking containers

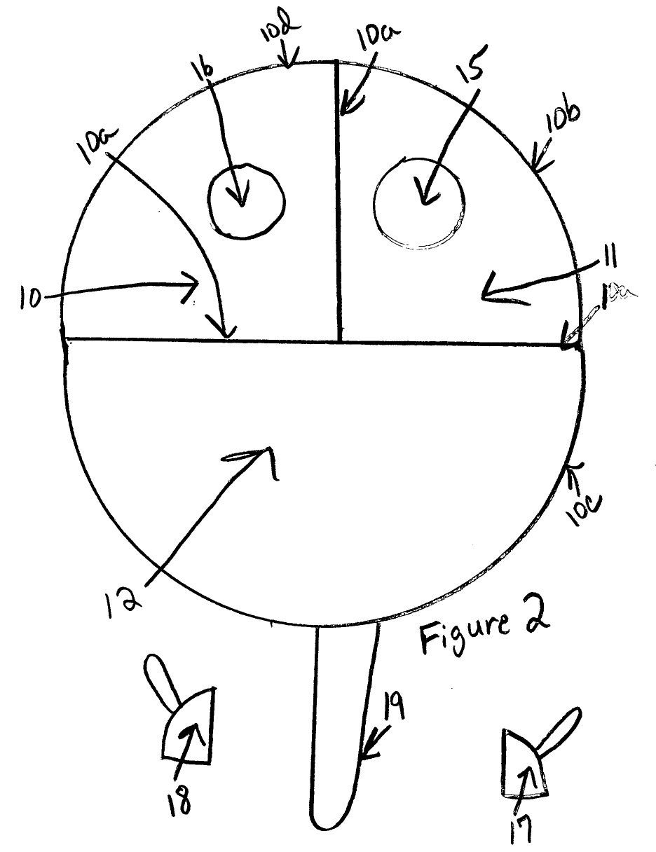

### REFERENCE NUMERICAL IN DRAWINGS FIG. 2

10a dividing wall
10b bottom wall
10c a perimeter wall upwardly extending around the bottom wall
10d a upper edge defining an open top into the respective cooking container
10 cooking compartment
11 cooking compartment
12 cooking compartment
10a dividing wall
15 magnets
16 magnets
17 a smaller cooking container
18 a smaller cooking container
19 handle
17 smaller cooking container
18 smaller cooking container
20 lids for smaller cooking container
21 lids for smaller cooking container
22 handles for smaller cooking container
23 handles for smaller cooking container

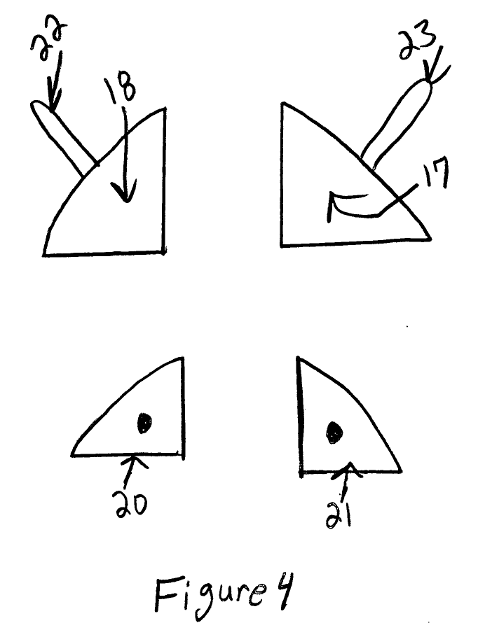

### REFERENCE NUMERICAL IN DRAWINGS FIG. 4

### Summary

A cooking container having a bottom wall, a perimeter side wall upwardly extending around said bottom wall, and an upper edge defining an open top into the respective cooking container. A cookware method of cooking a variety of food in one cooking container and the cookware having several cooking compartments. Also placing two smaller cooking containers in the cooking compartments. By using two small magnets, putting one in each cooking compartments, or can be used with or without the smaller magnets and smaller cooking containers. By placing the smaller cooking containers on top of the magnets, help to keep the magnets in place while cooking.

### DESCRIPTION—FIGS. 1 TO 5

With references now to the drawings, and in particular to FIG. 1 through 5 thereof, a new compartmentalized cookware system embodying the principles and concepts of the present invention will be described. As best illustrated in FIGS. 1 through 5, the compartmentalized cookware system generally comprises at least one cooking container having a bottom wall, a perimeter side wall upwardly extending around the bottom wall, and an upper edge defining and open top into the respective cooking container. The cooking container has at least two dividing walls therein upwardly extending from the bottom wall of the respective cooking container and dividing the cooking container into a plurality of cooking compartments. In close detail, the cookware system comprises a plurality of cooking containers. 10a being the dividing walls, 10, 11 being the two substantial smaller cooking containers, 12 being the substantial larger cooking container, 15 and 16 are the magnets, that can be placed into the cooking container or constructed with the cooking container. 10b being the bottom wall, 10c a perimeter wall upwardly extending around the bottom wall, 10d a upper edge defining an open top into the respective cooking container and 19 being the handle.

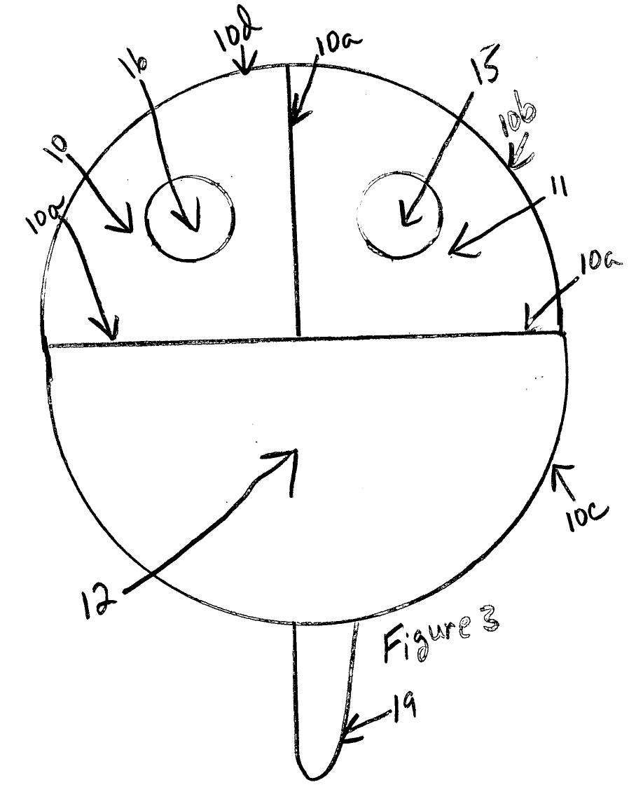

A third of the cooking container 10a is illustrated in FIG. 3, the third cooking container has dividing walls, 10a a dividing wall extending across a diameter connecting to form a pair of generally semi-circular cooking compartments 10, 11, and 12 being a larger compartment. 15 and 16 are magnets that can be placed used in the cooking container, magnets can be placed, used in the cooking container, magnets can be molded, constructed, placed in the cooking container, 10b a bottom wall, 10d a upper edge defining an open top into the respective cooking container, 10c a perimeter wall upwardly extending around the bottom wall and 19 a handle, 17 and 18 are the two small cooking containers.

A fourth of the cooking container 10a is illustrated in FIG. 5; the fourth of the cooking container has a dividing walls, a dividing wall extending across a diameter connecting to form a pair of generally semi-circular cooking compartments 10, and 11. Compartment 12 is a larger cooking compartment. 15 and 16 are two magnets that can be placed used in the cooking container, magnets can be molded, constructed, placed in the cooking container, they are used to hold the two smaller cooking container, that you placed on top of the magnets. 10b a bottom wall, 10d, a upper edge defining an open to into the respective cooking container, 10c a perimeter wall upwardly extending around the bottom wall and 19 the handle be attached to the cooking container. 17 a substantial size smaller cooking container, 18 a substantial size smaller cooking container, 20 is the lids or cover for the substantial size smaller cooking container. 21 is the lid or cover for the substantial size smaller cooking container. There are are handles being attached to the substantial smaller size containers.

In one embodiment, each cooking container may have a handle 19, coupled to the perimeter side wall of the respective cooking container adjacent the upper edge of the respective cooking container. Each of the cooking containers has at least two substantial planar dividing walls which is 10a. Therein upwardly extending from the bottom wall of the respective cooking container and couple to the perimeter side wall of the respective cooking container, to divide the respective cooking container into a plurality of cooking compartments 10, 11 and 12. Each designed for holding food, solid or liquid, therein separate from the other foods or liquids in the same cooking container and each food solid or liquid being in each separate container. With reference to FIG. 2; a first of the cooking containers 10a has one dividing wall extending across a diameter of the first cooking container to divide the first cooking container into a pair of semi-circular cooking compartments and 10a are the dividing walls to divide at the half way point of the divide walls to form a the three separate cooking compartments. There will be a bigger compartment which is 12. Also illustrated in FIG. 2; is a third of the cooking containers. There will be two magnets 15 and 16 that can be molded, constructed, placed in the cooking container or any other means of use can be used two place the two smaller cooking containers on top of the magnets in the cooking container.

In one embodiment, each cooking container may have a substantial size objects that can be placed or put into the cooking container, 17 and 18 are the smaller cooking container. There will be covers and lids for the two cooking containers 20 and 21. There will be handles the cooking container 22 and 23 for the smaller cooking container. The cooking container can be from 0 to 20 inches in diameter. The cooking container can be from 0 to 10 inches deep in the cooking containers. The two smaller cooking containers can from 0 to 10 inches deep and 0 to 10 in diameter, so it can fit in the overall cooking container. The smaller cooking containers can be designed to fit in the cooking container smaller cooking compartment.

### OPERATION—FIGS. 1, 4, 5

FIG. 1, description of cooking container “Operation of Cooking Container” references 10, 11 12 are the cooking compartments, the cooking compartments will hold solid or liquid food or material. There are dividing walls 10a, that will separate the food from being in contact with another. 10d a upper edge defining a open top into the respective cooking container, to place additional smaller cooking container to fit or use in the cooking compartment. 10b the bottom wall, the side of the cooking container is use to help the holding place of the cooking compartment for cooking food. 10c a perimeter wall upwardly extending around the bottom wall, part of the cooking container, is used for holding and placing food, 19 the cooking handle is used to pick up the cooking container. All of the reference numbers and parts relate to one another and relate to cooking food or liquids in the cooking container. FIG. 1., Is a description of the cooking container not having the magnets or the two smaller cooking container, that can be used in the cooking container. The cooking container can be used to cook a variety of food or other uses, 10a the dividing walls create three separate cooking compartments 10, 11 and 12. 10, 11, and 12 are the cooking containers reference numbers to help make the cooking container structure. FIG. 1; the operation are cooking a variety of food, solid or liquids in one cooking container for almost in human to use. My theory of operation is to use the cooking container to make, cook and use to cook a variety of food. You can take food in and out of the cooking container up to as many times as a human likes. By using all of the reference stated above and parts named, can be used to create a different and unique way of cooking food in one cooking container. FIG. 5; “Operation of Cooking Container” references number 10, 11 and 12 are the cooking compartment, the cooking compartments will hold solid or liquids foods or material, it helps to keep the food or solid and liquids separate and not touching each other, by the food, solid or liquids in each cooking compartment. 10a are the dividing walls that will separate the food and also they create the three separate cooking compartments, also the dividing walls interconnect with each other. 10b the bottom wall, the side of the cooking container is use to hold place of the cooking compartment for cooking food. 10c a perimeter wall upwardly the bottom wall. 10d a upper edge defining a open top into the respective cooking container, to put into or place additional smaller cooking containers into the cooking container. 15 and 16 are the magnets that can be placed into, made with cooking container or used for any other means, the magnets will be used by placing the smaller containers on top of the magnets, the magnets will be used in the two cooking compartment or all three cooking compartments. 17 and 18 are the two smaller cooking containers, that will be used in the cooking container. 19 is the handle for the cooking container, 20 and 21 are the lids or the covers for the smaller cooking containers and 22 and 23 are handles for the smaller cooking containers. With FIG. 5; all of the parts and reference numbers relate together and for cooking food, solids or liquids into one container. The operation is to use the cooking container to make, cook and use foods or solids or liquids to make a variety of food or materials for humans to use in a cooking container. By using all of the reference numbers stated above and the parts named, they can be used to create a different and unique way of cooking food in one cooking container. FIG. 4: “Operation of Cooking Container” there are two smaller cooking containers that can be placed in the cooking container. Reference numbers 17 and 18 are the two smaller containers, that can be placed in the two similar size cooking compartment. Inside of the cooking container there can be two small magnets that can be placed in the two similar size cooking containers. 20 and 21 are the lids or covers for the smaller cooking containers. 22 and 23 are the handles for the cooking container. The two smaller cooking containers relate to one another, because you can place FIG. 4, into FIG. 5. As stated above you can either place the two smaller cooking containers into the cooking container or use the cooking container with or without the smaller cooking containers or the two small magnets.

### OBJECTS AND ADVANTAGES

Accordingly, besides the objects and advantages of the cooking container described in my above patent, several objects and advantages of the present invention are:
(a) the advantages are you can cook up to three different meals or combinations of food at one time;
(b) you can boil liquids in the cooking container;
© you can place a smaller size cooking container in the cooking container;
(d) a magnet can be constructed, or put in the cooking container, where the magnets can help to place the smaller containers on top of the magnets;
(e) by having two magnets, and one magnet being in each similar size cooking compartment it will stabilize the cooking area of the smaller cooking container or to make sure the cooking container can have two small cooking containers to cook a variety of food or liquids;
(f) by having three separate cooking compartments, and one being bigger than the two similar size cooking compartments, the two similar size cooking compartments can be used to have either the magnets or the smaller size cooking container, to be placed in the overall cooking container;
(g) there is a larger cooking compartment that can be used to cook bigger cuts of meats, or to boil liquids and solid foods;
(h) the cooking container can be oval, round, rectangular, square, triangular or any other shape;
(I) you can cook in the cooking container with or without the smaller cooking containers, In that way having a different combination of cooking food or liquids;
(J) the smaller cooking containers will have lids to help cover the food while cooking;
(k) with the cooking container having one half of the cooking container for a bigger cooking compartment and the other half of the cooking container to have two similar cooking compartments;
(L) By having two dividing walls, one cutting the cooking container in half and the other divider cutting first divider in half creating two similar size cooking compartments;
(m) the two smaller cooking containers will have handles the way you can take the smaller cooking containers in and out of the overall cooking container;
(n) by having the dividers in the cooking container, you can cook the food in different sections of the cooking container;
(o) by having a teflon non-stick in the coating of the bottom of the cooking container, the food or liquids will not stick to the bottom of the cooking container;
(p) you can take the magnets in and out of the cooking compartments, there will be one In each similar size cooking compartment;

From the description stated above, a number of advantages of my cooking container becomes evident.

### DISADVANTAGES

(1) The cookware system has three compartments
(2) The cookware system has two divided walls

### DESCRIPTION OF INVENTION

A cookware container of a cookware system of FIG. 5; shows an overall view of the cooking container of the invention the cooking container, 10a is the dividing wall that interconnect again with 10a, by interconnecting the two dividing walls, and having the first dividing wall (10a) extend from one side of the cooking container to the other side of the cooking container, that creates three separate cooking compartments. The compartments are 10, 11, and 12, then you can place the two magnets, placing one in each similar size cooking compartments, or the magnets can be constructed with the cooking container. Also the cooking container can also be used to cook food or liquids with out the smaller cooking containers or even the magnets that you place in the cooking compartments and then you place the smaller cooking containers on top of the magnets. There is a bottom wall 10b. A perimeter wall upwardly extending around the bottom wall which is 10c. An upper edge defining an open top into the respective cooking container which is 10d. The cookware container can be 9 to 12 inches in diameter and being 9 to 12 inches round. The two magnets I mentioned above is 15 and 16. The two smaller cooking containers I mentioned above are 17 and 18. The overall cooking container has a handle which is 19. The two smaller cooking containers has handles which are 22 and 23. The smaller cooking containers can have lids or covers to place on top of the cooking container which are used to cover the food while cooking. The whole theory is to cook food in one cooking container and placing other smaller cooking containers to be placed in the same cooking container. The smaller cooking containers can have magnets in each similar sizes cooking compartment, you then can place the smaller cooking compartments on top of the magnets. Like I mentioned above, the cooking container can also be used to cook food with the magnets and the cooking container. I preferred to use both methods of the cooking container, which is using the magnets and the smaller cooking containers at the same time and using the cookware container without the magnets and the smaller cooking containers. The cooking container is a unique and in theory a great idea.

I claim:

1. A cookware system, comprising:
at least one cooking container having a bottom wall, a perimeter side wall upwardly extending around said bottom wall, and an upper edge defining an open top into the respective cooking container;
wherein container cooking container having at least two dividing walls therein upwardly extending from said bottom wall of the respective cooking container and dividing said cooking container into a plurality of cooking compartments; and
means for having metals different metals together to said cooking container is generally cylindrical such that said bottom wall of said cooking container is generally circular and said perimeter side walls of said cooking container is generally cylindrical; and
a preferred embodiment of a magnet can be part of a cookware system housing, other suitable material are contemplated.

2. The cookware system of claim 1, wherein said cooking container has a handle coupled to said perimeter side wall of the cooking container adjacent said upper edge of the cooking container.

3. The cookware system of claim 2, wherein said two substantial size smaller cooking containers can be used in or placed in the said cooking container into a pair of cooking compartments.

4. The cookware system of claim 1, wherein said cooking container two dividing walls extending across a diameter of said cooking container to divide said cooking container into a pair of cooking compartments.

5. The cookware system of claim 1, wherein said cooking container has two interconnected dividing walls outwardly radiating from a center axis of said cooking perimeter side wall of said cooking container to divide said cooking container into two generally triangular-wedge-shaped cooking compartments.

6. The cookware system of claim 5, wherein said dividing walls of said cooking container are spaced apart at one compartment being substantially size larger and the other compartments being spaced substantially of equal intervals such that said cooking compartments of said cooking have substantial equal volume and width.

7. The cookware system of claim 4, wherein said cooking container will have one half of said cooking container will be used by cooking standing human.

8. The cookware system of claim 5, wherein said placing at least one sufficient size cooking container into said cookware system.

9. A cookware system, comprising:
a plurality of cooking containers each having a bottom wall, a perimeter side wall upwardly extending around said bottom wall, and a upper edge defining an open top into the respective cooking container;
a cooking container having at least two substantially planar dividing walls therein upwardly extending from said bottom walls of the respective cooking container into a dividing the respective cooking container and dividing the respective cooking container into a plurality of different sizes of cooking compartments;
a cooking container have two dividing walls extending across one half of the cooking container and then again at the said half way of the dividing wall said cooking container into a pair of generally semi-triangular-wedge cooking compartments.

10. The cookware system of claim 8, wherein said cooking container being circular said at least one half of cooking container being emptied and have at least two dividing walls placing across cooking container said being another dividing wall across first dividing wall said cooking container having at least two cooking compartments to place suitable sizes of cooking container into circular cooking container.

11. The cookware system of claim 9, wherein said cooking container could have two magnets being of substantial smaller size to fit into the said substantial smaller size compartments, being made with the cooking container or being placed into the said substantial smaller size compartments.

12. The cookware system of claim 9, wherein said cooking container having different cooking compartments such said cooking container can be used without the two magnets in said cooking container.

13. The cookware system of claim 9, wherein said cooking container having different cooking compartments can be used with or without the said substantial smaller size cooking containers.

14. A cookware system, comprising:
each of said cooking containers having at least two substantially planar dividing walls therein upwardly extending from said bottom wall of the respective cooking container and diving the respective cooking container into a plurality of cooking compartments;
a first of said cooking containers having two dividing walls extending across a diameter of said first cooking container to divide a said first cooking container into a pair of generally semi-circular cooking compartments and sizeable larger cooking compartment;
each of said smaller cooking container for placing into said cooking container having an associated lid resting on said upper edge of the respective cooking container to substantially cover said open top of the respective cooking containers;
each of said lids having a generally dome-shaped-configuration comprising a concave lower face and a convex upper face, and as outer peripheral edge;
wherein said inner faces of said bottom and perimeter side wall said dividing walls of said cooking containers each having substantially coextensive non-stick coating provided thereon for the said cooking container and said substantially smaller cooking containers;
each of said lids having a lid handle coupled to said outer face of the respective lid at a center point on said outer face of the respective lid for;
said cooking container having a handle coupled to said outer face of the respective lid at a center point on said outer face of the respective cooking container;
